(19) United States
(12) Patent Application Publication
(10) Pub. No.: US 2011/0162169 A1
(43) Pub. Date: Jul. 7, 2011

(54) SELF-LOCK HINGE

(76) Inventor: Chia-Chun Sheng, Shulin (TW)

(21) Appl. No.: 12/683,494

(22) Filed: Jan. 7, 2010

(51) Int. Cl. E05F 1/08

(52) U.S. Cl. 16/297

(57) ABSTRACT

A self-lock hinge is mounted between a cover and a base of an electronic device and has a receiving bracket, an outer resilient sleeve, an inner resilient sleeve and a pintle. The pintle is connected to the cover and the receiving body is connected to the base. The outer resilient sleeve is mounted in the receiving bracket. The inner resilient sleeve is mounted in the outer resilient sleeve and has a positioning protrusion. The pintle is mounted through the inner resilient sleeve and has a flat wall selectively abutting against the positioning protrusion. When the cover is closed relative to the base, the flat wall of the pintle abuts the positioning protrusion to lock the cover. Therefore, the cover is self-locked when closing.

### BACKGROUND OF THE INVENTION

1. Field of the Invention

The present invention relates to a self-lock hinge, especially to a self-lock hinge mounted between a cover and a base of an electronic device.

2. Description of the Prior Arts

Notebook computers, cell phones are electronic devices and are widely used in modern life. The electronic device has a cover and a base. The cover may be pivoted relative to the base via the conventional hinge. However, when the cover is closed to attach to the base, additional locking mechanism is required to hold the cover at closing position. The additional locking mechanism not only cost more, but also occupies more inside room of the electronic device. Therefore, the electronic device has less room to accommodate electrical components used to provide more functions.

To overcome the shortcomings, the present invention provides a self-lock hinge to mitigate or obviate the aforementioned problems.

### SUMMARY OF THE INVENTION

The main objective of the present invention is to provide a self-lock hinge to allow the cover to self-lock on the base when closing so that the lock mechanism is no more needed. The self-lock hinge is mounted between the cover and the base of the electronic device and has a receiving bracket, an outer resilient sleeve, an inner resilient sleeve and a pintle. The pintle is connected to the cover and the receiving body is connected to the base. The outer resilient sleeve is mounted in the receiving bracket. The inner resilient sleeve is mounted in the outer resilient sleeve and has a positioning protrusion. The pintle is mounted through the inner resilient sleeve and has a flat wall selectively abutting against the positioning protrusion. When the cover is closed relative to the base, the flat wall of the pintle abuts the positioning protrusion to lock the cover. Therefore, the cover is self-locked when closing.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a self-lock hinge in accordance with the present invention;

FIG. 2 is an exploded perspective view of the self-lock hinge in FIG. 1;

FIG. 3 is a perspective view of an inner resilient sleeve of the self-lock hinge in FIG. 1;

FIG. 4 is another perspective view of the inner resilient sleeve in FIG. 3;

FIG. 5 is an operational end view of the self-lock hinge in FIG. 1, shown closed;

FIG. 6 is an operational end view of the self-lock hinge in FIG. 1, shown opened;

FIG. 7 is a perspective view of an inner resilient sleeve of a second embodiment of a self-lock hinge in accordance with the present invention;

FIG. 8 is another perspective view of the inner resilient sleeve in FIG. 7;

FIG. 9 is a perspective view of an inner resilient sleeve of a third embodiment of a self-lock hinge in accordance with the present invention;

FIG. 10 is another perspective view of the inner resilient sleeve in FIG. 9;

FIG. 11 is another perspective view of the self-lock hinge in FIG. 1;

FIG. 12 is a perspective view of a fourth embodiment of a self-lock hinge in accordance with the present invention; and

FIG. 13 is a perspective view of a fifth embodiment of a self-lock hinge in accordance with the present invention.

### DETAILED DESCRIPTION OF THE PREFERRED EMBODIMENTS

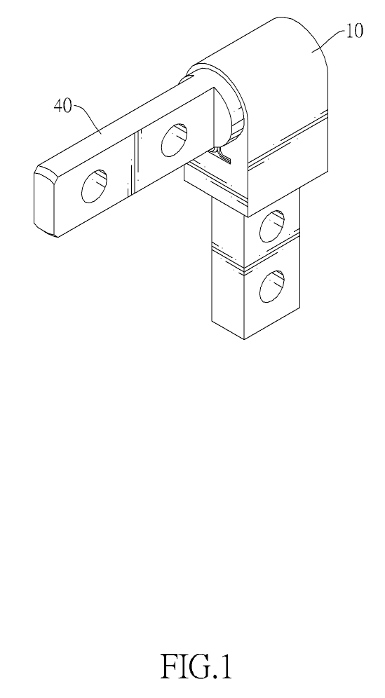

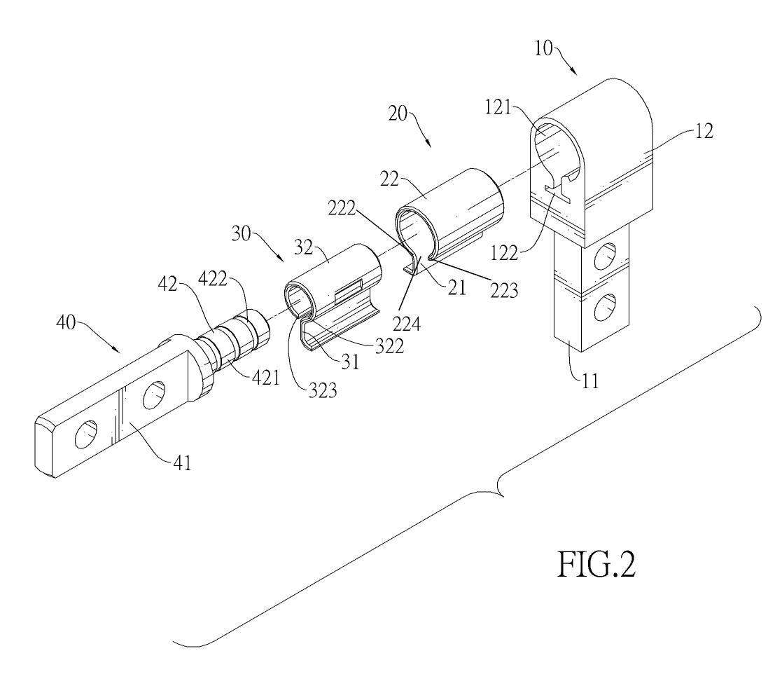

With reference to FIGS. 1 and 2, a self-lock hinge in accordance with the present invention comprises a receiving bracket (10), an outer resilient sleeve (20), an inner resilient sleeve (30) and a pintle (40).

The receiving bracket (10) has a connecting segment (11) and a mounting segment (12). The mounting segment (12) is formed on a side edge of the connecting segment (11) and has a longitudinal hole (121) and a keyway (122). The longitudinal hole (121) is formed axially through the mounting segment (12). The keyway (122) is formed in an inside wall of the mounting segment (12) and communicates with the longitudinal hole (121).

The outer resilient sleeve (20) is mounted in the mounting segment (12) of the receiving bracket (10) and has an outer connecting wing (21) and an outer tubular body (22). The outer connecting wing (21) is keyed in the keyway (122) of the mounting segment (12). The outer tubular body (22) protrudes from and is bent from a side edge of the outer connecting wing (21) and is mounted in the longitudinal hole (121) of the mounting segment (12).

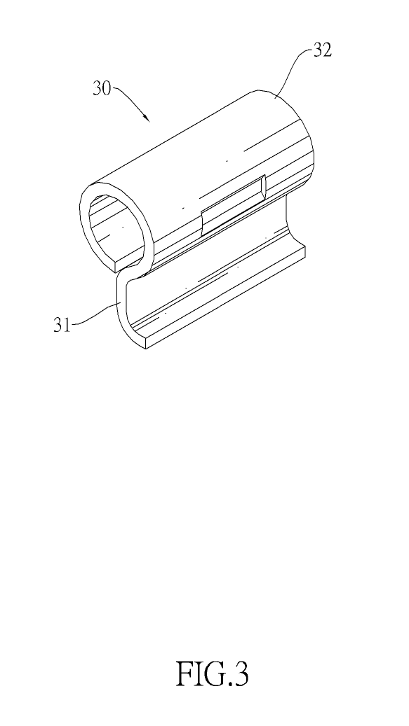

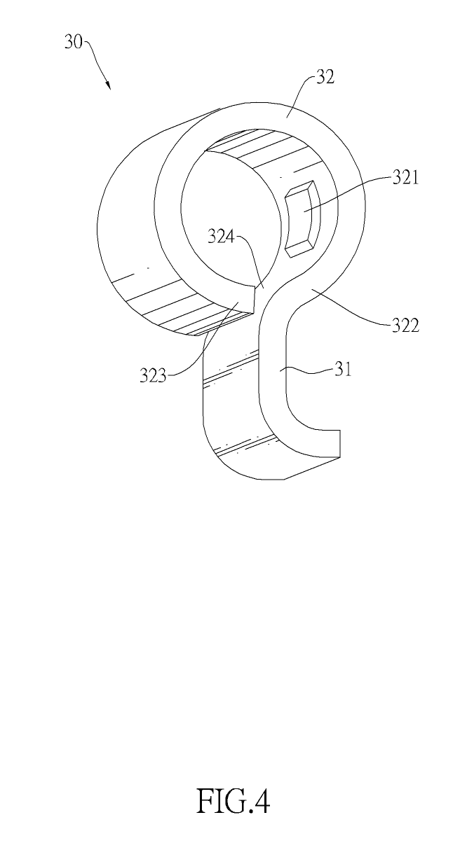

With reference to FIGS. 2 to 4, the inner resilient sleeve (30) is mounted in the mounting segment (12) of the receiving bracket (10) and has an inner connecting wing (31) and an inner tubular body (32). The inner connecting wing (31) is keyed in the keyway (122) of the mounting segment (12) and is attached to the outer connecting wing (21) of the outer resilient sleeve (20). The inner tubular body (32) protrudes from and is bent from a side edge of the inner connecting wing (31), is mounted in the outer tubular body (22) and has a proximal edge (322), a distal edge (323), a gap (324) and a positioning protrusion (321). The proximal edge (322) is connected to the inner connecting wing (31). The distal edge (323) is separated from the proximal edge (322). The gap (324) is formed between the proximal and distal edges (322, 323) to allow the inner tubular body (32) to be expand or retracted. The positioning protrusion (321) is formed on an inside wall of the inner tubular body (32) and is formed by recessing from an outside wall of the inner tubular body (32).

The pintle (40) is connected to the inner tubular body (32) of the inner resilient sleeve (30) and has a rod (42) and a fastening segment (41). The rod (42) is mounted rotatably through the inner tubular body (32) and has a flat wall (421) and a spiral groove (422). The flat wall (421) is formed on an outside wall of the rod (42) and selectively abuts against the positioning protrusion (321) of the inner tubular body (32). The spiral groove (422) is formed in the outside wall of the rod (32) to accommodate lubricant. The fastening segment (41) protrudes longitudinally from an end of the rod (42).

The self-lock hinge as described is mounted between a cover and a base of an electronic device. The fastening segment (41) of the pintle (40) is connected to the cover. The connecting segment (11) of the receiving bracket (10) is connected to the base. When the cover is pivoted relative to the base, the pintle (40) is rotated relative to the inner resilient sleeve (30).

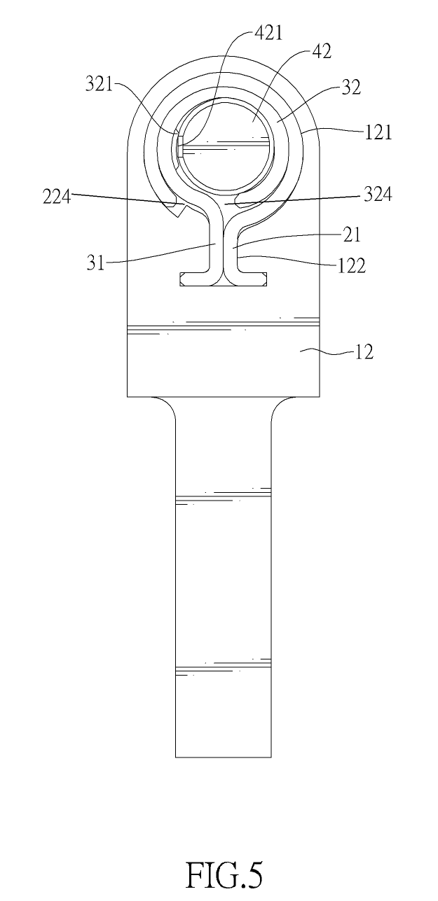

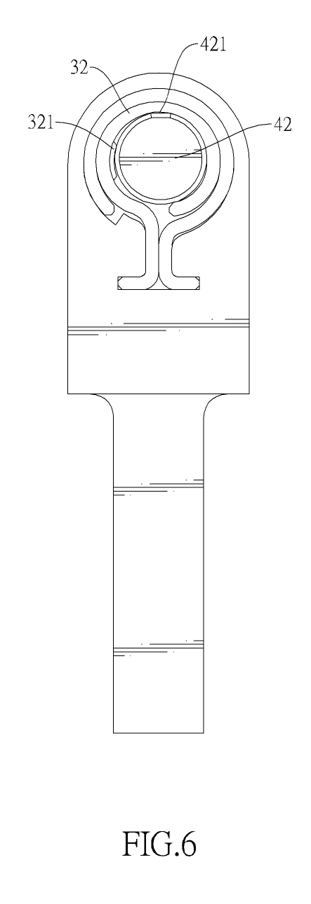

With reference to FIGS. 5 and 6, when the rod (42) of the pintle (40) is rotated relative to the inner tubular body (32) of the inner resilient sleeve (30), the outside wall of the rod (42) rubs against the positioning protrusion (321). When the flat wall (421) of the rod (42) abuts against the positioning protrusion (321), the rod (42) is held in position to provide positioning function so that the cover is locked. By properly assembling the self-lock hinge with the cover and the base, the cover is closed relative to the base when the flat wall (421) of the rod (42) abuts against the positioning protrusion (321). Therefore, the positioning function locks the cover to remain being closed relative to the base.

The self-lock hinge as described has following advantages. Since the cooperation between the positioning protrusion (321) and the flat wall (421) provides positioning function, lock mechanism is no more required. Therefore, the cost for the electronic device is reduced, and the electronic device has more room for accommodating the electrical components to provide more function.

The self-lock hinge in accordance with the present invention has basic structure as mentioned above. The alternative structures are described below.

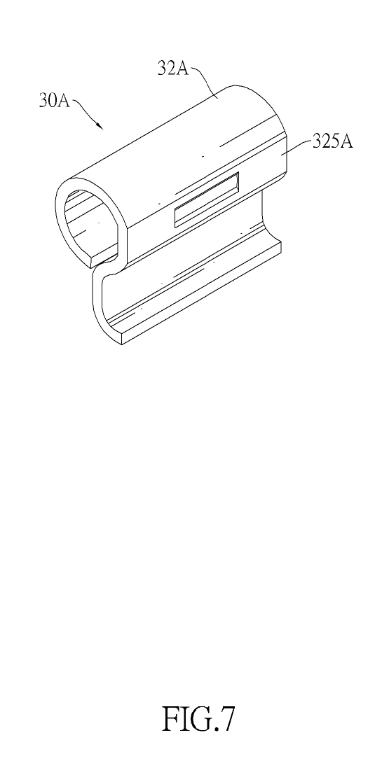

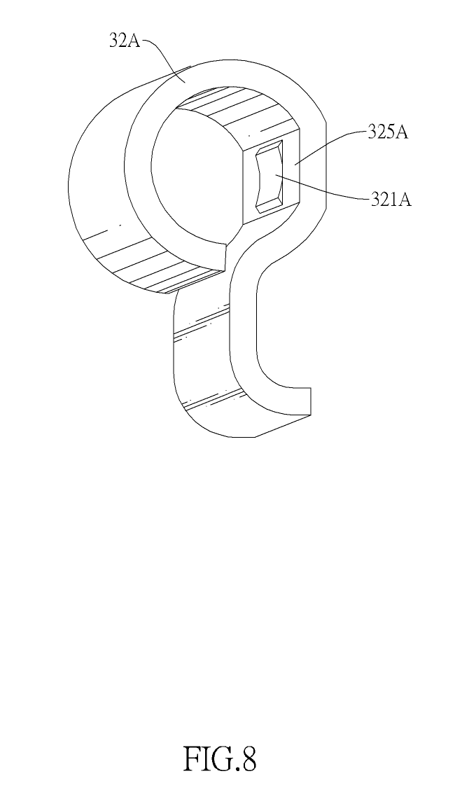

In preferred embodiments as shown in FIGS. 7 to 10, the inner tubular body (32A, 32B) of the inner resilient sleeve (30A, 30B) has a flat surface (325A, 325B) formed on the outside wall thereof. The positioning protrusion is formed on the flat surface (325A, 325B).

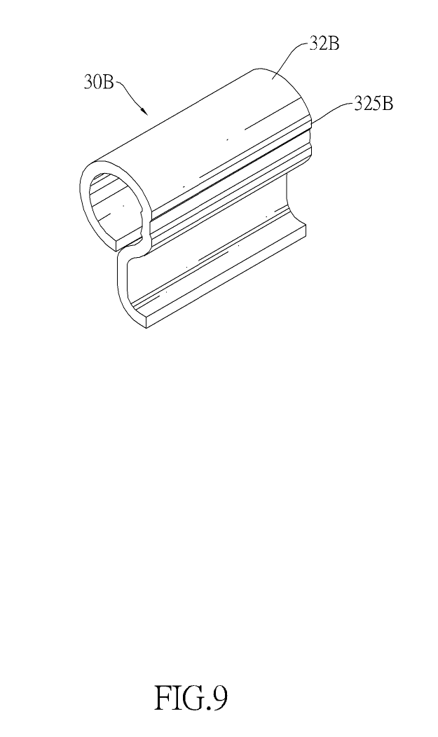

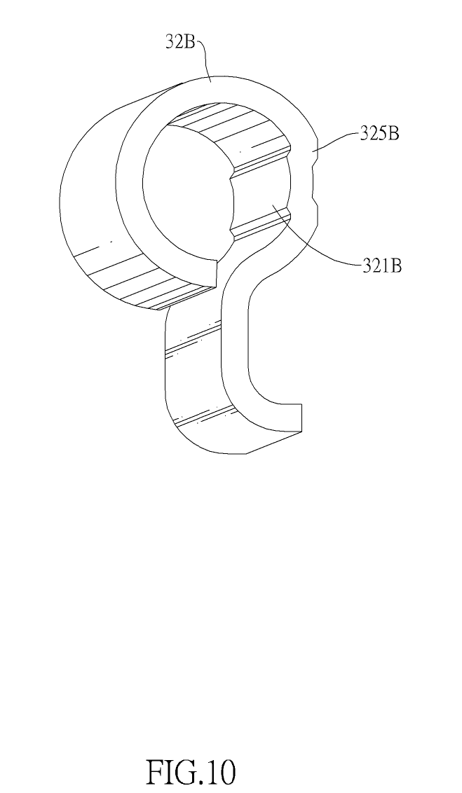

In preferred embodiments as shown in FIGS. 9 and 10, the positioning protrusion (321B) of the inner tubular body (32B) of the inner resilient sleeve (30B) extends longitudinally to end openings of the inner tubular body (32B) to increase the abutting area with the flat wall of the rod.

The keyway of the mounting segment and the connecting wings may have different shapes.

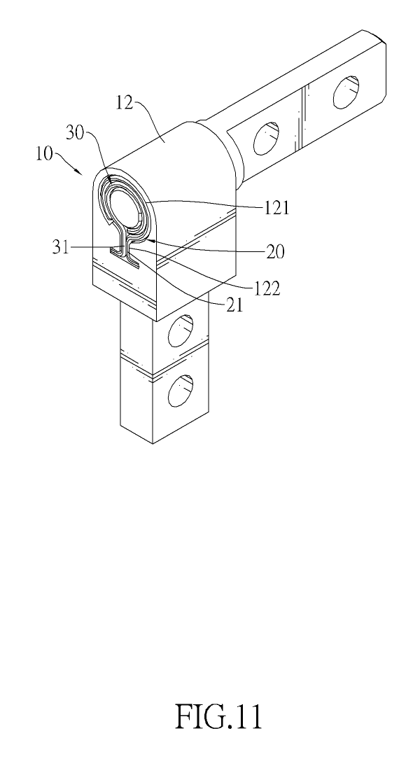

In a preferred embodiment as shown in FIG. 11, the keyway (122) of the mounting segment (12) is T-shaped in cross section and has one central way and two sideways. The central way communicates with the longitudinal hole (121) and the sideways extend perpendicularly toward opposite sides. The connecting wings (21, 31) of the outer and inner resilient sleeves (20, 30) are L-shaped in cross section. The outer connecting wing (21) is keyed in the central way and one of the sideways, and the inner connecting wing (31) is keyed in the central way and the other one of the sideways.

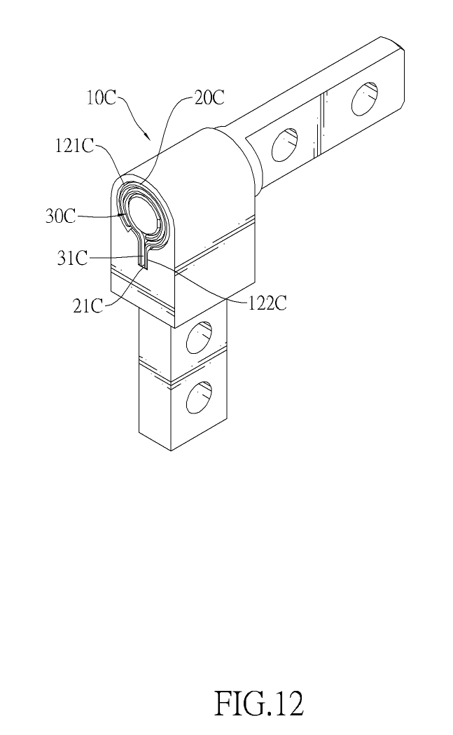

In a preferred embodiment as shown in FIG. 12, the keyway (122C) of the mounting segment (12C) is elongated. The connecting wings (21C, 31C) of the outer and inner resilient sleeves (20C, 30C) are elongated.

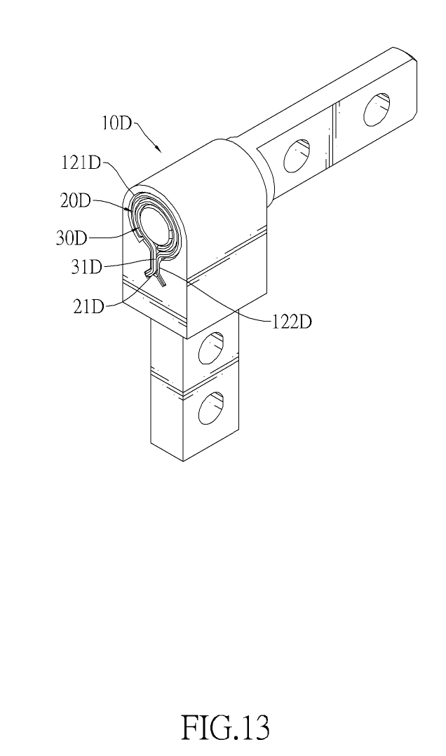

In a preferred embodiment as shown in FIG. 13, the keyway (122D) of the mounting segment (12D) is Y-shaped in cross section and has one central way and two sideways. The central way communicates with the longitudinal hole (121D) and the sideways extend obliquely toward different sides. The connecting wings (21D, 31D) of the outer and inner resilient sleeves (20D, 30D) are bent. The outer connecting wing (21D) is keyed in the central way and one of the sideways, and the inner connecting wing (31D) is keyed in the central way and the other one of the sideways.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

1. A self-lock hinge comprising:
a receiving bracket having
a connecting segment; and
a mounting segment formed on a side edge of the connecting segment and having
a longitudinal hole formed axially through the mounting segment; and
a keyway formed in an inside wall of the mounting segment and communicating with the longitudinal hole;
an outer resilient sleeve mounted in the mounting segment of the receiving bracket and having
an outer connecting wing mounted in the keyway of the mounting segment; and
an outer tubular body protruding from and bent in a first direction from a side edge of the outer connecting wing, mounted in the longitudinal hole of the mounting segment and having
a proximal edge connected to the outer connecting wing;
a distal edge separated from the proximal edge; and
a gap formed between the proximal and distal edges;
an inner resilient sleeve mounted in the mounting segment of the receiving bracket and having
an inner connecting wing mounted in the keyway of the mounting segment and attached to the outer connecting wing of the outer resilient sleeve; and
an inner tubular body protruding from and bent in a second direction from a side edge of the inner connecting wing, mounted in the outer tubular body and having
a positioning protrusion formed on an inside wall of the inner tubular body and formed by recessing from an outside wall of the inner tubular body;
a proximal edge connected to the inner connecting wing;
a distal edge separated from the proximal edge; and
a gap formed between the proximal and distal edges and misaligning with the gap of the outer tubular body; and
a pintle connected to the inner tubular body of the inner resilient sleeve and having
a rod mounted rotatably through the inner tubular body and having
a flat wall formed on an outside wall of the rod and selectively abutting against the positioning protrusion of the inner tubular body; and
a fastening segment protruding longitudinally from an end of the rod;
wherein the first direction and the second direction are opposite to each other.

2. The self-lock hinge as claimed in claim 1, wherein
the outer connecting wing is keyed in the keyway of the mounting segment; and
the inner connecting wing is keyed in the keyway of the mounting segment.

3. The self-lock hinge as claimed in claim 2, wherein
the keyway of the mounting segment is T-shaped in cross section and has
one central way communicating with the longitudinal hole; and
two sideways extending perpendicularly toward opposite sides;
the outer connecting wing is L-shaped in cross section and is keyed in the central way and one of the sideways; and
the inner connecting wing is L-shaped in cross section and is keyed in the central way and the other one of the sideways.

4. The self-lock hinge as claimed in claim 2, wherein
the keyway of the mounting segment is elongated; and
the connecting wings of the outer and inner resilient sleeves are elongated.

5. The self-lock hinge as claimed in claim 2, wherein
the keyway of the mounting segment is Y-shaped in cross section and has
one central way communicating with the longitudinal hole; and
two sideways extending obliquely toward different sides;
the outer connecting wing is bent and is keyed in the central way and one of the sideways; and
the inner connecting wing is bent and is keyed in the central way and the other one of the sideways.

6. The self-lock hinge as claimed in claim 1, wherein
the inner tubular body of the inner resilient sleeve has a flat surface formed on the outside wall thereof; and
the positioning protrusion is formed on the flat surface.

7. The self-lock hinge as claimed in claim 3, wherein
the inner tubular body of the inner resilient sleeve has a flat surface formed on the outside wall thereof; and
the positioning protrusion is formed on the flat surface.

8. The self-lock hinge as claimed in claim 4, wherein
the inner tubular body of the inner resilient sleeve has a flat surface formed on the outside wall thereof; and
the positioning protrusion is formed on the flat surface.

9. The self-lock hinge as claimed in claim 5, wherein
the inner tubular body of the inner resilient sleeve has a flat surface formed on the outside wall thereof; and
the positioning protrusion is formed on the flat surface.

10. The self-lock hinge as claimed in claim 1, wherein the positioning protrusion of the inner tubular body of the inner resilient sleeve extends longitudinally to end openings of the inner tubular body.

11. The self-lock hinge as claimed in claim 3, wherein the positioning protrusion of the inner tubular body of the inner resilient sleeve extends longitudinally to end openings of the inner tubular body.

12. The self-lock hinge as claimed in claim 4, wherein the positioning protrusion of the inner tubular body of the inner resilient sleeve extends longitudinally to end openings of the inner tubular body.

13. The self-lock hinge as claimed in claim 5, wherein the positioning protrusion of the inner tubular body of the inner resilient sleeve extends longitudinally to end openings of the inner tubular body.
